(19) United States
(12) Patent Application Publication
(10) Pub. No.: US 2013/0166467 A1
(43) Pub. Date: Jun. 27, 2013

(54) System and Method for Military Education Benefits Analysis

(71) Applicants: Craig V. Carroll, Aspen, CO (US); David M. Childress, Sacramento, CA (US); Christiane Thy Nguyen, West Sacramento, CA (US); Tuongvy Dao, West Sacramento, CA (US); Matthew Kevin McCarthy, Roseville, CA (US)

(72) Inventors: Craig V. Carroll, Aspen, CO (US); David M. Childress, Sacramento, CA (US); Christiane Thy Nguyen, West Sacramento, CA (US); Tuongvy Dao, West Sacramento, CA (US); Matthew Kevin McCarthy, Roseville, CA (US)

(73) Assignee: REZOLVE GROUP, INC., Sacramento, CA (US)

(21) Appl. No.: 13/337,806

(22) Filed: Dec. 27, 2011

(51) Int. Cl. G06Q 50/20

(52) U.S. Cl. 705/327

(57) ABSTRACT

A computerized method for determining eligibility of military education benefits and calculating an award estimate based on each service member's individual personal, financial, and military background information. Potential students enter information via a user interface of the computer system. In response to the entered information, the computer system presents additional relevant questions based on the previous information entered by the service member. The computer system uses the entered information to provide a detailed and customized calculation of the total estimated aid.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

Many academic institutions provide admission, enrollment, and cost information to prospective students via their websites. This is especially true for post-secondary institutions. These academic institutions often provide detailed cost information, such as the tuition, room and board costs, and miscellaneous costs, which typical students might be required to pay as a consequence of their attendance at the academic institution. Additionally, it is common for students to receive educational benefits based on military service.

The United States government funds several military education benefit programs (or benefit programs) for individuals serving in the various branches of the armed forces and their family members. Service members are often eligible to receive aid from multiple different benefit programs and different service members often qualify for different benefit programs. This is because each benefit program has different eligibility requirements and the service members generally have unique personal, financial, and military histories. Additionally, many service members want to transfer their military education benefits to spouses or dependants to enable their family members to use benefits that might otherwise go unused.

While the United States Department of Veteran Affairs and Department of Defense do supply some information such as the general requirements or how much each benefit program will pay to eligible service members (or their spouse/dependant), they do not provide any benefit calculations or detailed explanations customized to individual service members. And some privately developed systems have had only limited capabilities such as covering only individual programs and only the service member's benefits for themselves.

To further complicate the process, service members also have access to additional funding sources such as grants, scholarships, other federal and state aid programs, and student loans. All of these different funding sources can be applied in many different combinations to help reduce the cost of attending an academic institution. Thus, service members often have trouble determining for which programs they qualify, how much assistance they will receive and/or need, and how to and whether they can transfer benefits to a spouse or dependant.

### SUMMARY OF THE INVENTION

With so many different benefit programs, eligibility requirements, and funding options it can be laborious for service members (or their spouse/dependants) to determine for which benefit programs they qualify, how much they would be awarded, how to maximize their financial assistance and minimize debt, and how to decide which benefit are best for their needs. This confusion results in potential students failing to utilize benefit programs for which they are eligible or making uninformed decisions regarding the affordability of attending an academic institution. In worst case scenarios, some potential students may completely avoid all post secondary education due to the mistaken belief that it is not affordable.

The present invention is directed to a computer system and computerized methods for determining eligibility of military education benefits and calculating an award estimate based on each service member's individual personal, financial, and military background information. Potential students enter personal, financial, and military background information via a user interface of the computer system. In response to the entered personal, financial and military background information, the computer system presents additional relevant questions based on the previous information entered by the service member.

The computer system uses the entered information to compare the service member's information against the eligibility requirements for federal, state, and military education benefit programs. Then the computer system presents the potential student with possible benefit programs, additional funding sources, and an estimated award amount that the service members are likely to receive. In this way, each service member (or family member) is provided a detailed and customized calculation about the total estimated aid from military education benefit programs.

The computer system also includes additional funding sources such grants, scholarships, and federal and state aid to calculate a total estimated grant and loan aid amount. The entered information can then be parsed and used to help the potential student apply for benefits with the appropriate department or agency by automatically transferring entered information to benefit program applications and/or directly to the department or agency.

In general, according to one aspect, the invention features a computerized method for determining military education benefits for attending an academic institution. The method includes a computer system generating a user interface for receiving personal information of a candidate, the personal information including military background information. The method also includes the computer system selecting among possible military aid programs based on the military background information provided by the candidate. In one example, the computer system determines eligibility for multiple military aid programs. Lastly, the method includes that upon selection of a military aid program, a total amount of military aid is calculated for the candidate and the computer system displays the total amount of military aid for the candidate.

In general, according to another aspect, the invention features, a computerized method for determining military education benefits for attending an academic institution. The method includes the computer system generating a user interface for receiving personal information of a candidate, the personal information including military background information for a parent. The method further includes the computer system enabling the candidate to indicate eligibility under a transfer of benefits program. The method includes the computer system calculating a total amount of military aid for the candidate and the computer system displaying the total amount of military aid for the candidate.

In general, according to another aspect, the invention features, a computerized method for determining military education benefits for attending an academic institution. The method includes the computer system generating a user interface for receiving personal information of a candidate, the personal information including military background information for a parent or deceased or injured spouse. The method also includes a computer system enabling the candidate to indicate whether the parent or spouse was injured or killed in relation to their service. Lastly, the method includes the computer system to calculate a total amount of military aid for the candidate and the computer system to display the total amount of military aid for the candidate.

In general, according to another aspect, the invention features, a computerized method for determining transferable military education benefits from a service member to a candidate. The method includes the computer system generating a user interface for receiving personal information of a candidate, the personal information including whether the candidate is a spouse or dependant of the service member. The method also includes that if the candidate is the spouse or dependant of the service member, calculating a total amount of transferrable military aid that can be received from the service member. Finally, the method includes the computer system displaying the total amount of transferrable military aid.

In general, according to another aspect, the invention features a computerized method for determining military education benefits for attending an academic institution. The method includes the computer system generating a user interface for receiving personal information of a candidate, the personal information including military background information. The method further includes that in response to entered personal and military background information, determining possible military aid programs the candidate is eligible to receive. The method also includes the computer system automatically selecting military aid programs and calculating a total amount of military aid for the candidate and the computer system displaying the total amount of military aid for the candidate.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a block diagram showing the relationship between service members, representative, advisors, or other candidates, the military education benefits website and web server, the computer system for determining and calculating military education benefits, and additional computer systems.

FIG. 2 is a hybrid block diagram and flow chart illustrating the steps a candidate, advisor or representative performs to access the computer system, complete the survey, and apply for financial benefit programs.

FIG. 3A shows the military education benefits screen generated by the military education benefits web server and how potential students are able to select their current military status from a military status menu.

FIGS. 3B and 3C shows the military education benefits screen generated by the military education benefits web server and how the computer system presents different data fields to a potential student in response to different selections in the military status menu.

FIGS. 4A-4F shows the military education benefits screen generated by the military education benefits web server and how the computer system presents different questions, data fields, and military benefit programs in response to the personal and military background information entered by the potential students.

FIG. 5 shows the personal finances screen generated by the military education benefits web server illustrating an example of typical personal financial questions for collecting financial information about the potential student and spouse and/or dependant (if applicable).

FIG. 6 is an example if a data summary screen generated by the military education benefits web server that displays the potential student's personal, financial, and military background information.

FIGS. 7-8 are examples of an estimated eligibility aid screen generated by the military education benefits web server showing how the computer system generates personalized estimated eligibility aid calculations based on the personal, financial, and military background information entered about each service member.

### DETAILED DESCRIPTION OF THE PREFERRED EMBODIMENTS

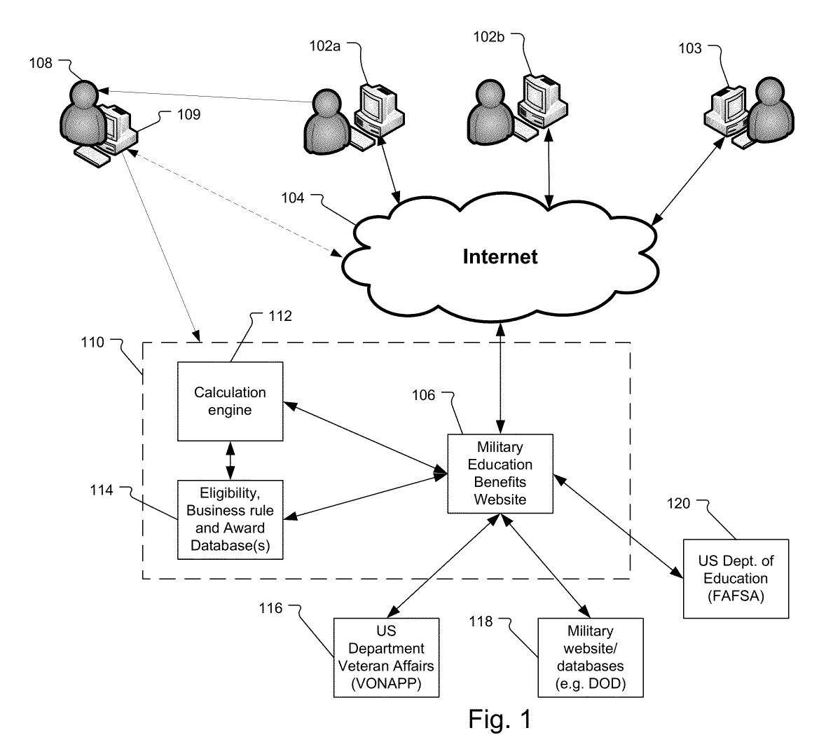

FIG. 1 is a block diagram showing the relationship between service members or other candidates 102a and 102b, the military education benefits website and web server 106, the computer system 110 for determining and calculating military education benefits, and additional computer systems 116, 118.

In a typical implementation, potential students (or candidates) 102a and 102b use personal computing devices such as laptops, desktop computers, tablet devices, or smart phones to access a military education benefits website 106 of the computer system 110. Typically, the military education benefits website 106 is hosted by a third party service provider. In alternative embodiments, the military education benefits website 106 is hosted by an academic institution as part of the institution's cost of attendance calculator.

Generally, potential students access the military education benefits website with an Internet browser via a public network such as the Internet 104 or mobile broadband network. In an alternative embodiment, the potential students may access the website from a computer terminal or kiosk located on a campus of the academic institution or provided by a branch of the military or Department of Defense on a military base or ship.

The computer system 110 generates a graphical user interface (or user interface) that is presented to the potential students 102a-and 102b as a series of served web pages. The series of served web pages (referred to as a survey) displays questions, selectable fields, drop-down menus, and data entry fields to enable the potential student to enter personal, financial, and military background information generated by the computer system 110. In response to the information entered by the potential student, the computer system 110 generates additional questions, selectable fields, drop-down menus, and data entry fields that are relevant to the entered information of the potential student.

In an alternative embodiment, the potential student contacts a representative 108 working in a call center. The representative 108 asks the questions presented by the user interface to the potential student and enters the received responses into the user interface displayed on the representative computer 109. Generally, the representative computer 109 is connected directly computer system 110 via a private network. In one embodiment, the representative 108 uses a proprietary user interface designed to help the representative guide the potential students through the survey. In another embodiment, the representative 108 accesses the military education benefits website 106 via the Internet 104 with the representative computer 109 and asks the questions presented by the computer system 110 and enters the potential student's responses.

In another alternative embodiment, the potential student or candidate is able to meet with an advisor (or counselor) 103 that would help the potential student complete the survey. The adviser 103 could be an employee for an academic institution, the military (e.g. Department of Veteran Affairs or Department of Defense), or an employee of a third party company, to list a few examples.

The computer system 110 further includes an eligibility, business rule, and award database (database) 114 and a calculation engine 112. The database 114 stores all of the survey information such as the eligibility criteria for each of the programs, business and business logic, award amounts and requirements, and the information entered by the potential student, to list a few examples. Additionally, all of the eligibility criteria, business rules and/or logic, and calculation algorithms are adaptable and modifiable. This is because the military benefits programs, eligibility criteria, award amounts, and packaging criteria for the different benefit programs change annually (or more frequently) based on federal and/or state legislation and regulations.

The calculation engine 112 of the computer system 110 is a software program executed by the computer system 110 that performs the eligibility determinations, award determinations, and calculations for the potential students. The calculation engine 112 uses the information entered by the potential student to determine which benefit programs the student is eligible to receive.

The calculation engine 112 also includes additional funding sources to generate a total of all grant and loan amounts. The total of all grant and loan amounts typically includes military education benefits, grants, scholarships, federal and state aid, and federal and private student loans.

In some embodiments, the computer system 110 communicates with other computer systems, websites, or databases of the United States Department of Veteran Affairs 116, military websites and/or databases 118 (such as the United States Department of Defense), and the United States Department of Education. Communicating with these other computer systems enables the computer system 110 to automatically transfer the user-entered information to the benefit program applications. Additionally, in other embodiments, the accuracy of the entered information is confirmed. For example, many of the benefit programs require completing an application through the Veterans On-Line Application (VONAPP) website. The VONAPP website is hosted by the U.S. Department of Veterans Affairs to allow service members to apply for benefit programs online. At the same time, information entered by the candidate, such as years of military service, is directly confirmed with the US Department of Veteran Affairs or Department of Defense in some embodiments.

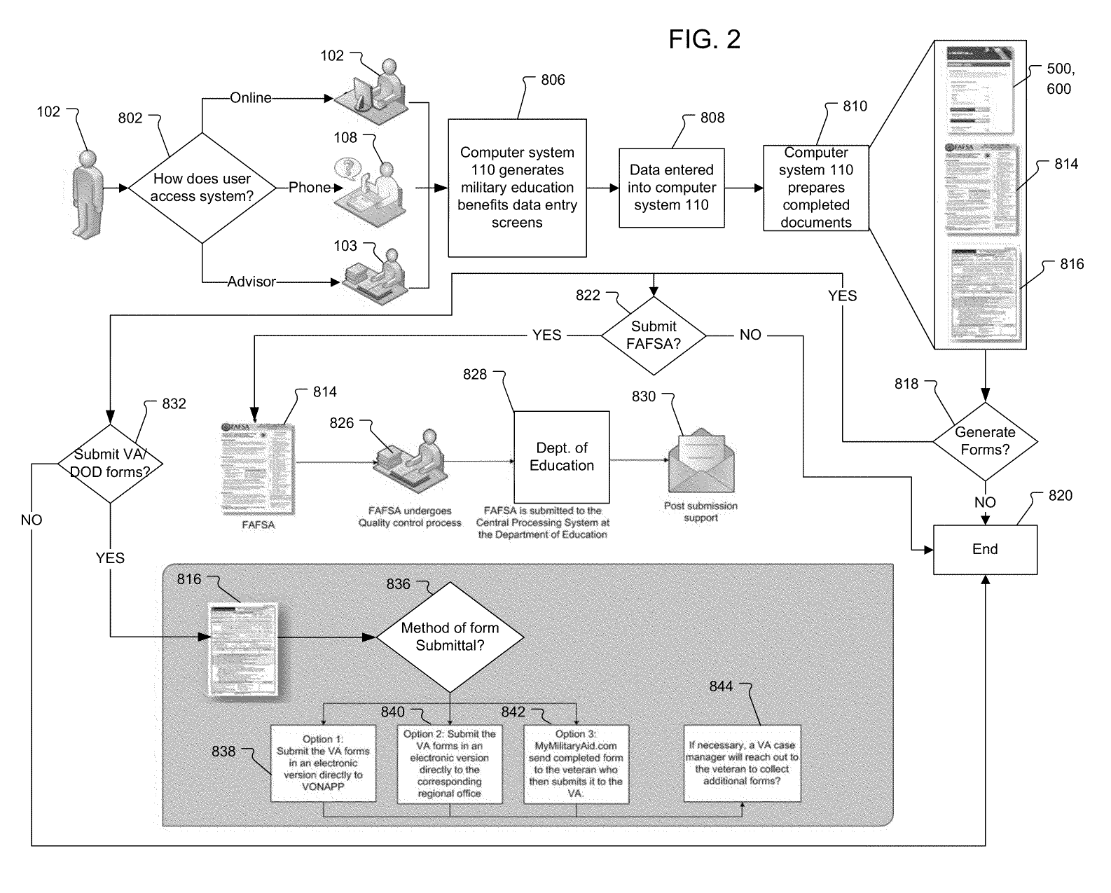

FIG. 2 is a hybrid block diagram and flow chart illustrating the steps a potential student or candidate or advisor performs to access the computer system 110, complete a survey, and submit applications for benefit programs and financial aid.

In the first step 802, a candidate 102 determines how they want to access the computer system 110. In a typical implementation candidates are able to access the computer system 110 via the Internet, by phone and calling a call center to speak with a representative 108, or by meeting an advisor 103.

Regardless of the method chosen to access the system, the computer system 110 generates the survey that includes the data entry, data summary, and award estimate screens in step 806. In the next step 808, data are entered into the computer system. Based on the entered information, the computer system 110 determines eligibility for multiple military aid programs based on the military background information of the candidate and calculates estimated award amounts and displays the data summary and award estimate screens 500, 600 for one or more of the programs for which the candidate is eligible. Additionally, the computer system also prepares completed benefit application documents 814, 816 and allows the potential student to review the entered information.

In the next step 818, the computer system 110 determines whether to generate the benefit application documents 814, 816 for submission based on the candidate's selection. If the candidate chooses not to generate the forms, then the computer system 110 saves the entered information in the database 114 and the application process is ended in step 820. Alternatively, the candidate is able to choose to delete all of their entered information and not have any information saved.

If the candidate chooses to generate the forms for submission, then the computer system 110 determines if the candidate wants to submit a FAFSA (Free Application for Federal Student Aid) to the United States Department of Education in step 822. Likewise the computer system 110 also determines if the candidates wants to submit an application to the United States Department of Veteran Affairs and/or the United States Department of Defense in step 832. Candidates are able to select whether to submit applications only to the United States Department of Education, only to the United States Department of Veteran Affairs and/or the United States Department of Defense, or to all the agencies.

In an alternative embodiment, the computer system 110 automatically determines which applications need to be generated based on the entered information and the potential student's eligibility. Thus, for example, if the potential student is eligible to have all of their school expenses covered by a military education benefit program, then the computer system 110 determines that there is no need to generate a financial aid documents for others loan or grants.

If candidates elect to submit a FAFSA document 814 to the Department of Education, then the computer system 110 performs an additional quality control in step 826. The additional quality control ensures that the FAFSA is complete, that candidates have supplied correct information, and that any additional documentation is also included with the application to list a few examples. The FAFSA is then submitted to the central processing system at the Department of Education in step 828. In the next step 830, the computer system 110 provides post submission support such as status updates or additional information about the submission process.

The computer system 110 also enables candidates to cancel a FAFSA submission in progress. Even if the user previously elected to generate forms (in step 818), the candidate still is able to cancel the submission and end the application process. If the candidate chooses not to submit the FAFSA to the department of education, then the computer system ends the application process in step 820.

In step 832 the computer system 110 determines of the candidates want to submit the application documents 816 to the United States Department of Veteran Affairs and/or the United States Department of Defense. As before, the candidate is able to end the submission process and return to step 820.

If candidate chooses to submit the form to the United States Department of Veteran Affairs and/or the United States Department of Defense, then the computer system 110 determines the method to submit the form in step 836.

In a typical implementation, the candidate is able to choose how the forms are submitted by the computer system 110. The computer system 110 is able to submit an electronic version of the completed application documents through the VONAPP system in step 838. Alternatively, the computer system 110 submits an electronic version directly to a regional office of the United States Department of Veteran Affairs and/or the United States Department of Defense in step 840. In still another case, the computer system 110 sends the completed application to the candidate who then submits it to the United States Department of Veteran Affairs and/or the United States Department of Defense in step 842.

Lastly, the computer system 110 provides post submission support to the potential student. For example, the computer system provides status updates, progress updates, warning and/or alerts if the application is not completed, to list a few examples.

Likewise, if necessary, a case manager reaches out to the candidate (or veteran) to collect and any additional forms or information in step 844.

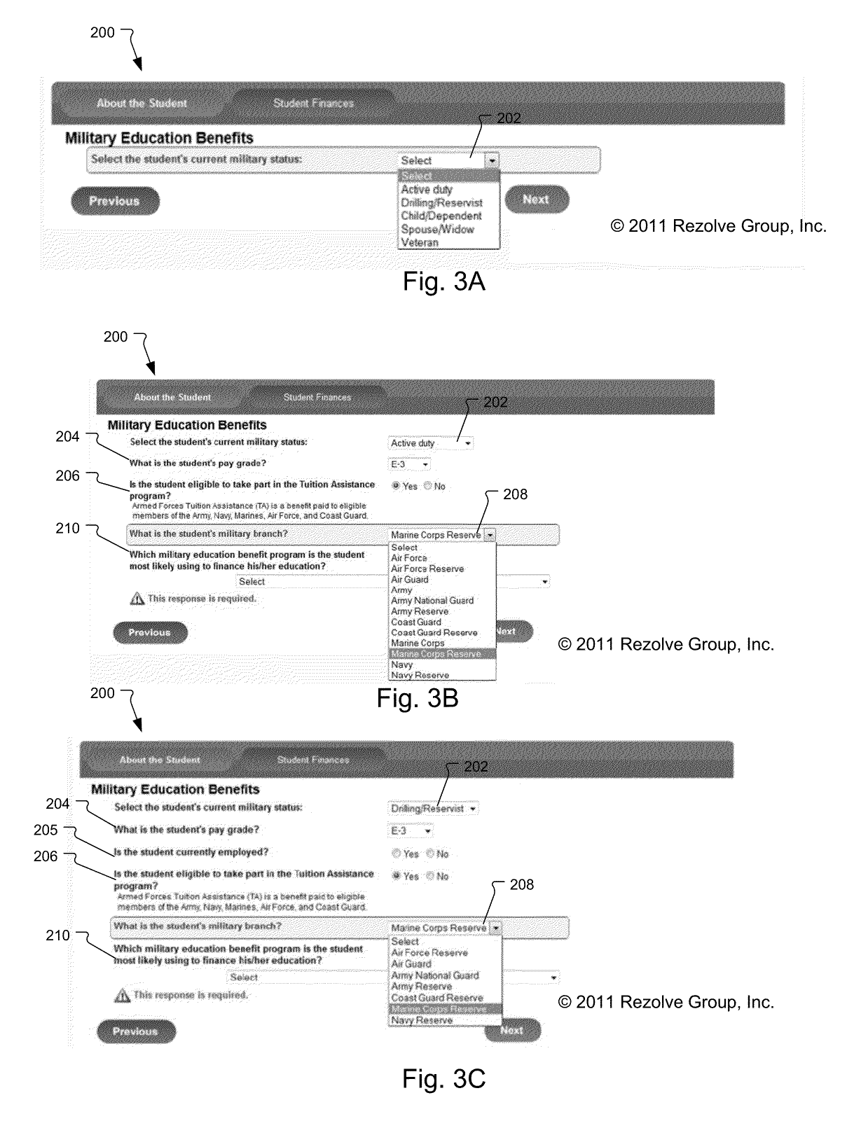

FIG. 3A shows an example of a military education benefits data entry screen 200 that is part of the survey the potential students are required to complete. In one implementation, the potential students or advisor are required to select their current military status from the military status selectable menu 202. In an alternative embodiment, the computer system 110 automatically determines the potential student's military status based on information accessed from military human resources (HR) databases or previously presented questions.

In the illustrated example, the selectable menu 202 is a drop-down menu that lists different military statuses such as Active Duty, Drilling/Reservist, Veteran, Child/Dependant, and Spouse/Widow. Based on the selection made by the potential student, additional questions, selectable fields, drop-down menus, and data entry fields are presented by the computer system. Likewise, selections made in one part of the survey affect what is displayed later in the survey and ultimately the final total benefit aid calculation. In an alternative embodiment, the survey presents questions that enable the computer system 110 to determine the potential student's eligibility for military education benefits instead of requiring the potential student to select the program that they are eligible to receive.

In alternative embodiments, military status categories could be removed or additional categories could be added. For example, categories for students involved in ROTC (Reserve Officer Training Corps) or categories for students that not in the armed forces but who are seeking information about military education benefits programs for which they might qualify if they were to join one of the military branches and attend an academic institution.

In a typical implementation, the military education benefits data entry screen 200 is presented after the potential students complete registration data entry screens of the survey (not shown). These registration screens require the potential students to enter personal information such as name, address, email address, telephone number, and academic history to list a few examples. In an alternative embodiment, completion of the registration screens is optional, but the computer system 110 will display a warning message to the potential students that the computer system 100 will be unable to submit applications without potential student's personal information. In still other examples, the potential student's information for the registration screens is gathered automatically from military human resources (HR) databases.

FIGS. 3B and 3C show the military education benefits data entry screen 200 and how the computer system 110 presents different questions, selectable fields, drop-down menus, and data entry fields to each potential students in response to previously entered information or different selections in the military status selectable menu 202.

For example, FIG. 3B shows an example of a potential student having selected active duty from the military status selectable menu 202. Based on this selection, the computer system 110 presents additional questions 204, 206, 210 and displays a military branch drop-down menu 208 that lists all of the possible branches that are or can be considered to have Active Duty.

Similarly, FIG. 3C shows the result of selecting Drilling/Reservist from the military status selectable menu 202. In the illustrated example, if the potential student selects Drilling/Reservist, then only the branches that having Drilling/Reservist members are displayed in the military branch drop-down menu 208. Likewise, an additional employment question 205 is added. This is because the Drilling/Reservist status enables the candidate to have another part/full time job in addition to the part-time military service. Moreover, income and work history are also factors in determining some education benefits available to the potential student. In contrast, a service member that is active duty would not be employed outside of the military. Thus, the computer system 110 would omit questions about employment outside of the military.

For each of the different military statuses, the computer system 110 presents different questions, selectable fields, drop-down menus, and data entry fields related to the selected military status. Likewise, the information that is entered on the military education benefits data entry screen 200 affects the other questions and selectable items presented later in the survey.

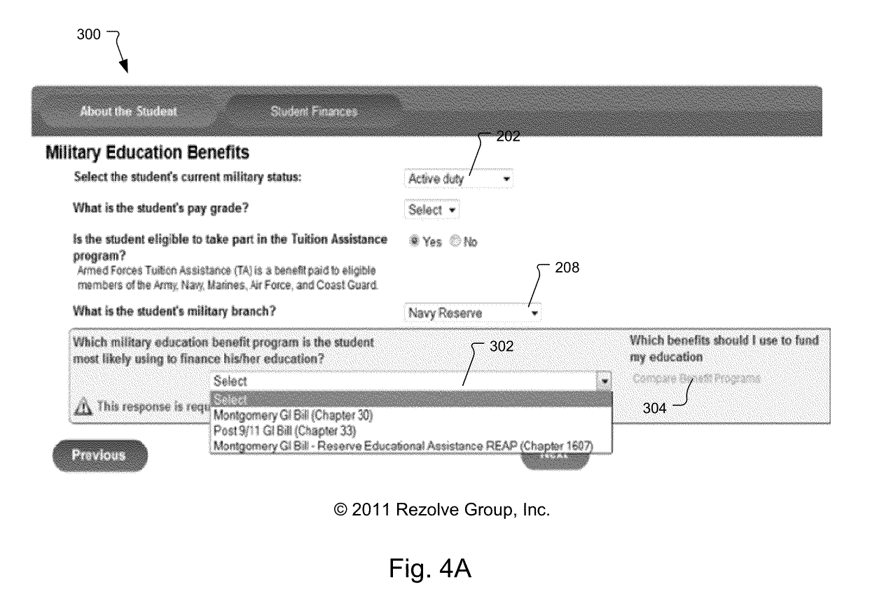

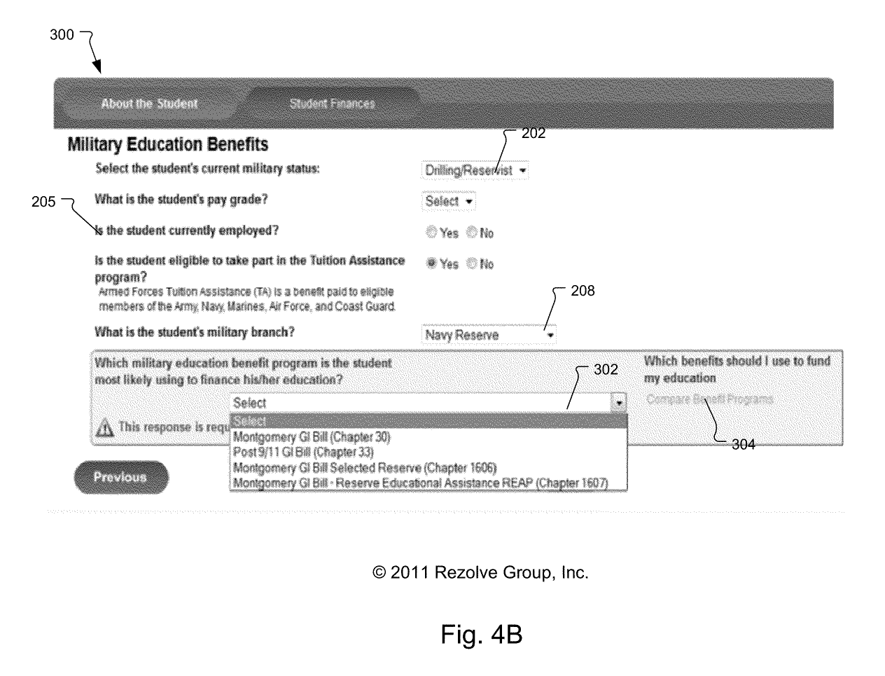

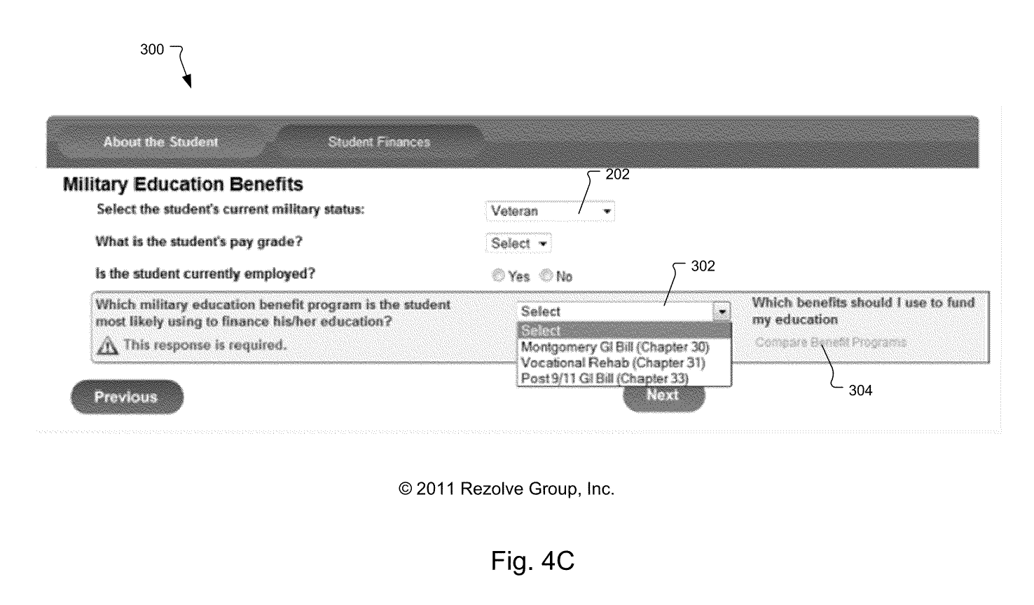

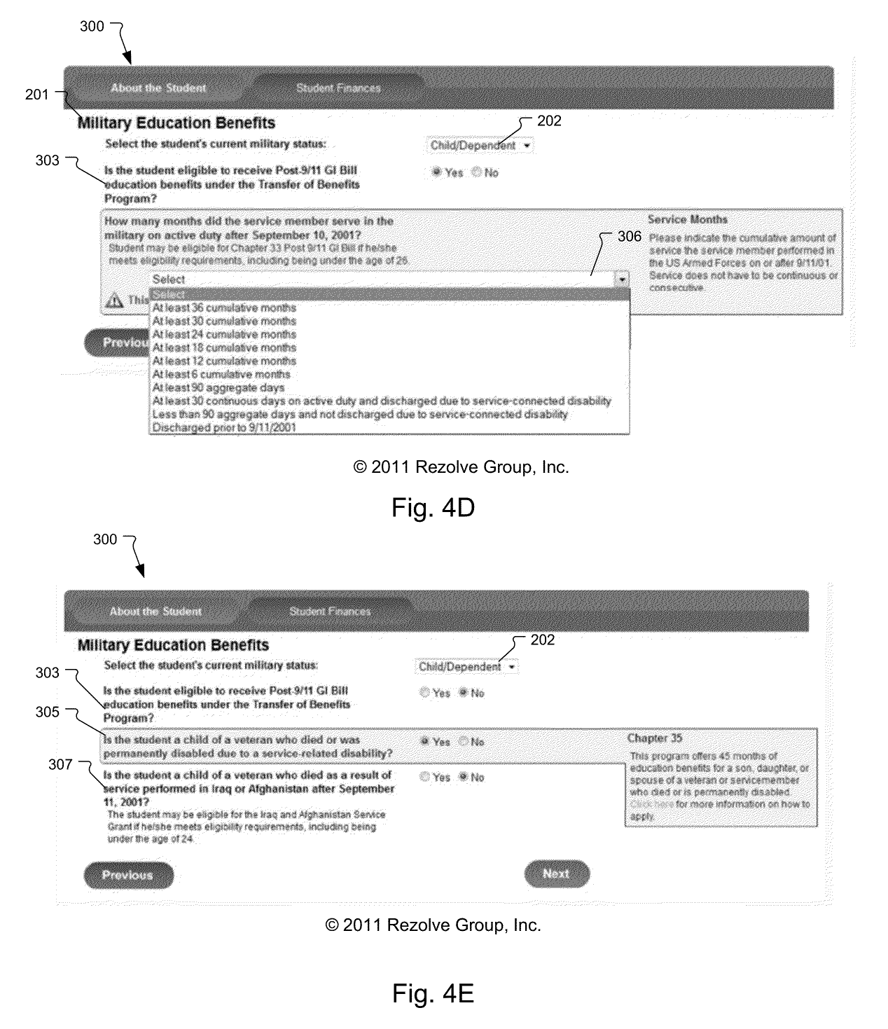

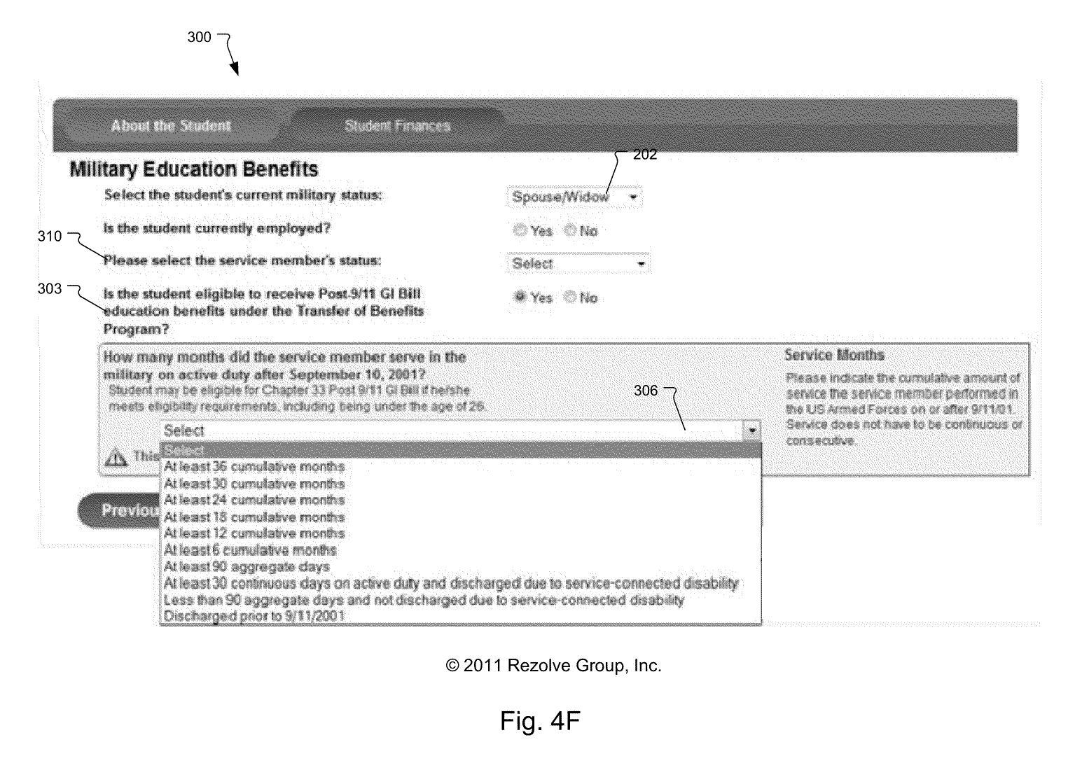

FIGS. 4A-4F shows another military education benefits data entry screen 300 and how the computer system 110 generates different questions, data entry fields, and military benefit programs that are displayed by the computer system 110 in response to the personal and military background information entered by the potential students. In an alternative embodiment, the computer system 110 automatically selects a benefit program (or multiple benefit programs) that the potential student is eligible to receive instead of requiring the potential student to select the program from a list. The computer system 110 makes this determination based on the information entered during the survey. Likewise, if the potential student is eligible to receive multiple benefits from the computer system 110 selects all of the benefit programs and combines the awards. Alternatively, the computer system 110 displays different awarding combinations and explains the features and benefits of the different programs.

Additionally, all of the eligibility criteria, business rules and/or logic, and calculation algorithms of the computer system are modifiable by system administrators. This adaptability is essential because the military benefits programs, eligibility criteria, award amounts, and packaging criteria for the different benefit programs change frequently based on federal and/or state legislation and regulations. Likewise, additional benefit programs could be created and/or other benefits programs could be cancelled.

FIG. 4A shows the military education benefits data entry screen 300 and illustrates an example of a potential student that has selected active duty from the military status selectable menu 202. Based on the selected status and answers to the additional questions, selectable fields, drop-down menus, and data entry fields, the computer system 110 determines which military benefit programs the potential student is eligible to receive. In the illustrated example, the potential student is eligible for the Montgomery GI Bill (chapter 30), post 9/11 GI Bill (chapter 33), and the Montgomery GI Bill—Reserve education assistance REAP (chapter 1607).

The Montgomery GI Bill (Chapter 30) program provides up to 36 months of education benefits to eligible veterans. To be eligible for the Montgomery GI Bill, the potential student must have an Honorable Discharge, must have a high school diploma or GED (or in some cases 12 hours of college credit), and their current military status must be Active Duty, Drilling/Reservist, or Veteran. The awarding is based on enrollment status and the length of the academic term (See Table I).

TABLE I
Chapter 30 - Benefit Rates
(as of Oct. 1, 2010)

| Enrollment Status | Monthly Rate |
|---|---|
| Full-time | $1,426.00 |
| Three-quarter-time | $1,069.50 |
| Half-time | $713.00 |
| Less-than-half-time | $713.00 |
| Quarter-time or less | $356.50 |

The Post 9/11 GI Bill (Chapter 33) pays candidates' tuition based upon the in-state tuition charged by the particular public educational institution in which the candidate is/will enroll or up to a fiscal year cap of $17,500 for private or foreign educational institution. Additionally, the post 9/11 GI Bill allowance covers up to $10,000 per academic year for non-degree flight training as well as lesser amounts for licensing and certification programs.

To be eligible for the Post 9/11 GI Bill the potential student's current military status must be Active Duty, Drilling/Reservist, or Veteran. The awarding is based on the service member's cumulative length of service (see Table II).

TABLE II
Chapter 33 - Benefit Rates
(as of Oct. 1, 2010)

| | Maximum Amount |
|---|---|
| Active Duty Service Post 9/11 | Payable |
| At least 36 months | 100% |
| At least 30 continuous days on active duty and | 100% |
| discharged due to service-connected disability | |
| 30 months to 36 months | 90% |
| 24 months to 30 months | 80% |
| 18 months to 24 months | 70% |
| 12 months to 18 months | 60% |
| 6 months to 12 months | 50% |
| 90 days to 6 months | 40% |

The Montgomery GI Bill—Reserve Educational Assistance REAP enables certain reservists who were activated for at least 90 days after Sep. 11, 2001 to be eligible for education benefits (or eligible for increased benefits). To be eligible for the Montgomery GI Bill—Reserve Educational Assistance REAP, the potential student's current military status must be Active Duty or Drill/Reservist. The awarding is based on enrollment status and the length on the academic term (see Table III).

TABLE III
Chapter 1607 - Benefit Rates
(as of Oct. 1, 2010)

| | Consecutive Service | Consecutive | Consecutive |
|---|---|---|---|
| Enrollment | of 90 Days but Less | Service of 1 | Service of 2 |
| Status | than 1 Year | Year+ | Years+ |
| Full-time | $570.40 | $855.60 | $1,140.80 |
| Three-quarter-time | $427.80 | $641.70 | $855.60 |
| Half-time | $285.20 | $427.80 | $570.40 |
| Less-than-half-time | $285.20 | $427.80 | $570.40 |
| Quarter-time or less | $142.60 | $213.90 | $285.20 |

The computer system 110 also enables candidates to compare the different programs by selecting the compare benefit program hyperlink 304. The compare benefit program hyperlink 304 provides potential students with additional information about the different benefits programs and enables students to compare programs side by side. This allows the potential students to better understand which programs they qualify for and which options would provide a better fit for their individual circumstances.

In a typical implementation, the potential student selects a military benefit program, for which the potential student has been determined eligible, from the military benefit program menu 302. This selection affects the subsequent questions, data fields, and calculations presented by the user interface later in the survey.

FIG. 4B shows the military education benefits screen 300 and illustrates an example of a potential student that has selected drilling/reservist from the military status selectable menu 202. In this example, the potential student qualifies for Montgomery GI Bill (chapter 30), Post 9/11 GI Bill (chapter 33), the Montgomery GI Bill Selected Reserve (chapter 1606), and the Montgomery GI Bill—Reserve education assistance REAP (chapter 1607).

The Montgomery GI Bill Selected Reserve (Chapter 1606) includes members of the Army Reserve, Navy Reserve, Air Force Reserve, Marine Corps Reserve and Coast Guard Reserve, the Army National Guard, and the Air National Guard. Eligible candidates are entitled to receive up to 36 months of education benefits and eligibility for the program normally ends on the day they leave the Selected Reserve. The awarding is based on enrollment status and the length of the academic term (see Table IV).

TABLE IV
Chapter 1606 - Benefit Rates
(as of Oct. 1, 2010)

| Enrollment Status | Monthly Rate |
|---|---|
| Full-time | $337.00 |
| Three-quarter-time | $252.00 |
| Half-time | $167.00 |
| Less-than-half-time | $84.25 |

FIG. 4C shows the military education benefits screen 300 and illustrates an example of a potential student that has selected veteran from the military status selectable menu 202. In response to the potential student's selection, the computer system 110 presents additional questions, selectable fields, drop-down menus, and data entry fields and lists the benefits programs the potential student is eligible to receive. In this example, the potential student is eligible to receive the Montgomery GI Bill (chapter 30), Vocational Rehab (chapter 31), and the post 9/11 GI Bill (chapter 33). The Vocational Rehab (Chapter 31) is only available to veterans and the awarding is up to the full amount of tuition and fees.

FIG. 4C also illustrates how different questions are omitted in response to previous selections made within the survey by potential students. For example, the military branch drop-down menu 208 is not displayed in this figure because a veteran would no longer belong to any of the service branches.

FIG. 4D shows the military education benefits screen 300 and illustrates an example of a potential student that selected child/dependant from the military status selectable menu 202. In the illustrated example, the potential student is able to transfer benefits through the Transfer Benefits Program (under the Post-9/11 GI Bill). The amount of transferrable benefits is based on the military status of the service member and their cumulative length of service. The Transfer of Benefits program enables service members to transfer Post-9/11 GI Bill benefits to a dependant or spouse so that family members are able to use military benefits that might otherwise go unused.

FIG. 4E shows the military education benefits screen 300 and illustrates an example of a child/dependant that does not qualify for the Transfer of Benefits Program. In response to the potential student's indication that they are unable to receive transferred benefits, the computer system 110 displays additional questions about the Dependents' Educational Assistance (Chapter 35) program. This benefit program provides education benefits for child/dependants of service members that died or were seriously injured due to a service related injury. Generally, this benefits program is available for child/dependants that are not eligible to receive benefits with the Transfer of Benefits Program of the Post 9/11 GI Bill.

The Dependents' Educational Assistance (Chapter 35) program offers up to 45 months of education benefits if the candidate is a son or daughter and wishes to receive benefits for attending school or job training The candidate must be between the ages of 18 and 26. Additionally, if the candidate is a spouse, then the benefits end 10 years from the date Veterans Administration finds the candidate eligible or from the date of death of the veteran.

For surviving spouses (i.e., spouses of service members who died on active duty) benefits end 20 years from the date of death. The awarding is based on enrollment status and the length of the academic term (see Table V).

TABLE V
Chapter 35 - Benefit Rates
(as of Oct. 1, 2010)

| Enrollment Status | Monthly Rate |
|---|---|
| Full-time | $936.00 |
| Three-quarter-time | $702.00 |
| Half-time | $466.00 |
| Less-than-half-time | $466.00 |
| Quarter-time or less | $234.00 |

Additionally, FIGS. 4D and 4E further illustrate how different selections made by potential students affect subsequent questions, selectable fields, drop-down menus, and data entry fields displayed in the user interface. By way of example, in FIG. 4D, the potential student (a child/dependant) selected “Yes” to the question of whether the potential student is eligible to receive benefits under the Post 9-11 GI Bill Transfer of Benefits Program 303. In response, the computer system displays a length of service question 306.

In contrast, in FIG. 4E, the potential student selected “NO” to the question of whether the potential student is eligible to receive benefits under the Post 9-11 GI Bill Transfer of Benefits Program 303. In response, the computer system caused the user interface to display additional question 305 related to The Dependents' Educational Assistance (Chapter 35) Program and question 307 related to Iraq Afghanistan Service Grant (IASG). The IASG is available to students whose parent or guardian was a member of the US Armed Forces and died in Iraq or Afghanistan due to services performed after Sep. 11, 2001. Student must also be ineligible for a Federal Pell Grant, be under the age of 24 and enrolled in college at least part-time at the time of the parent's/guardian's death

FIG. 4F shows the military education benefits screen 300 and illustrates an example of spouse/widow receiving transferred military education benefits from a service member. In response to the potential student's selection of the question of whether the potential student is eligible to receive benefits under the Post 9-11 GI Bill Transfer of Benefits Program 303, the computer system displays a length of service question 306.

An additional military benefits program (not shown in Figures) is the Military Spouse Career Advancement Account (MyCAA). To be eligible for the MyCAA program benefit the potential student must be a spouse/widow and the service member's current military status must be active duty or deceased. The award for the spouse/widow is $2000 per fiscal year with a maximum educational benefit of $4,000.

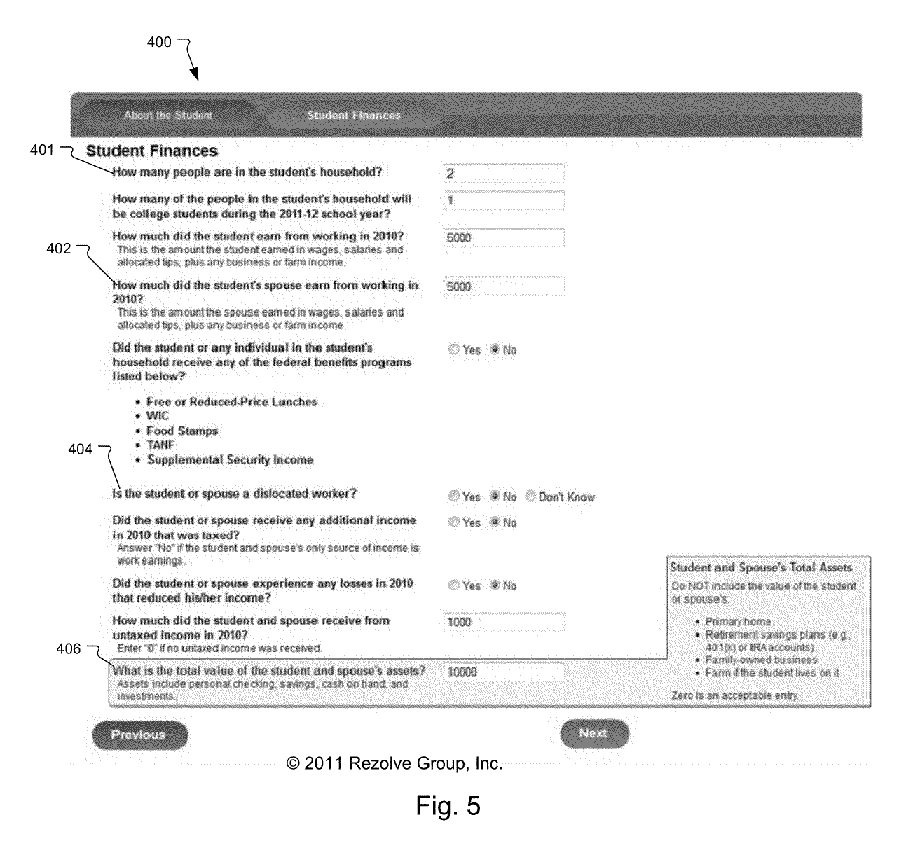

FIG. 5 shows an example of a financial information screen 400 that requires the potential students to enter financial information. The questions presented are based on the previously entered information from the survey. For example, if the potential student listed any spouse or dependants earlier during the personal information screens, then the computer system 110 displays questions 402, 404, 406 about the spouse's finances in addition to those of the potential student. If the potential student does not have a spouse or dependants, then these questions are omitted. Likewise, if the potential student is a spouse or dependant, then computer system presents additional questions about the service member's finances in addition to the questions for the potential student.

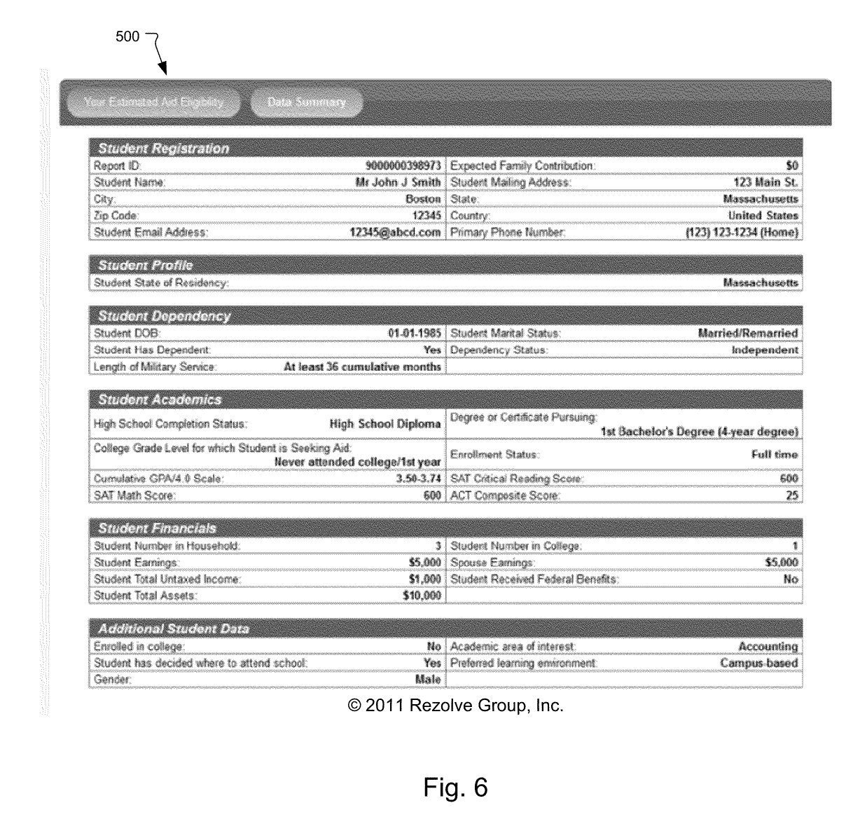

FIG. 6 is an example if a data summary screen that displays the personal, financial, and military information entered by the potential student. The report summary screen 500 is a detailed overview of all the information entered by the potential students during the survey. The summary allows the potential students to review the personal, financial, and military information entered during the survey. The potential students are then able to edit any missing or incorrect information by returning to the survey (not shown). Generally, the information shown in the report summary screen 500 is stored in the eligibility, business rules, and awards database 114.

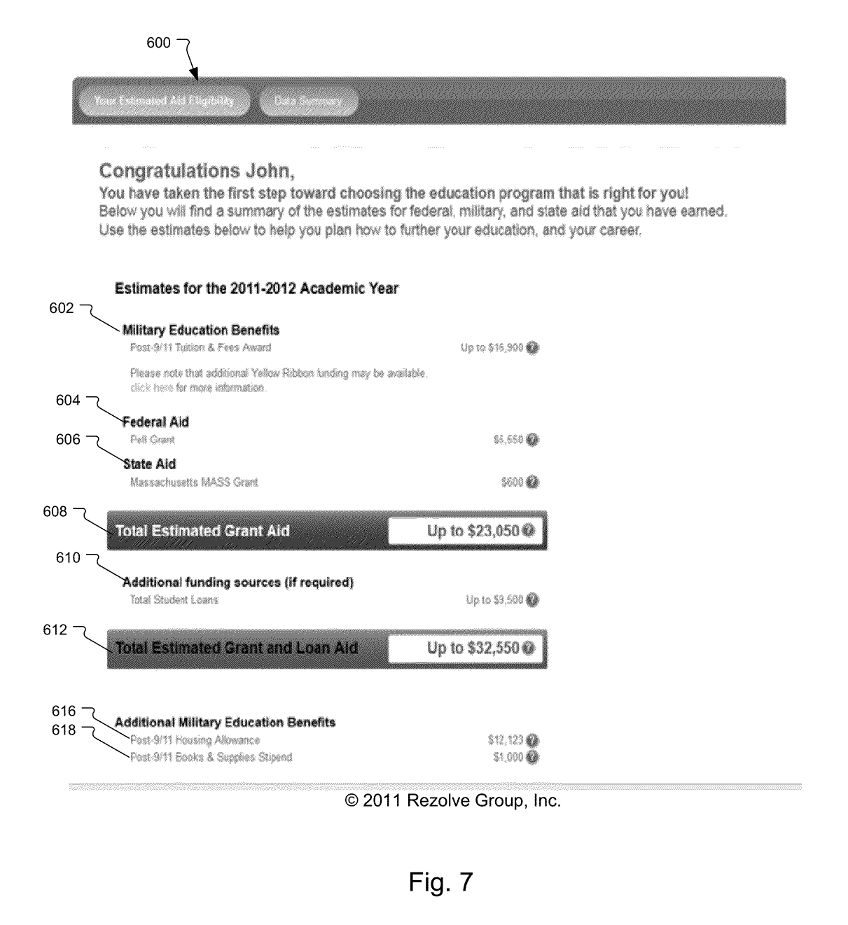

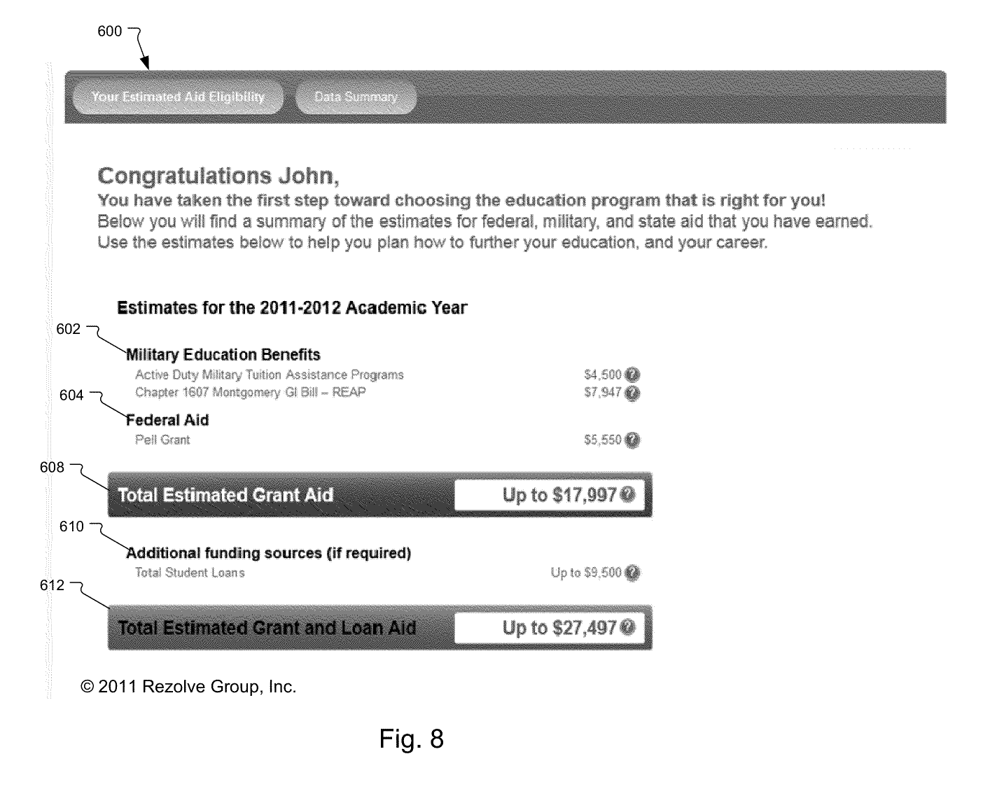

FIGS. 7 and 8 show two examples of estimated aid eligibility screens 600. These screens provide detailed explanations of the benefit programs, award amounts, and additional funding sources the potential student is eligible to receive. Additionally, FIGS. 7 and 8 further show how each potential student receives a customized award estimate based on the personal, financial, and military information entered by the potential student during the survey.

FIG. 7 illustrates one example of an estimated military education benefit screen 600 that is presented to a potential student upon competition of the survey by the web server 106. The computer system 110 generates a summary of the military education benefits 602 that the potential student is eligible to receive. In the illustrated embodiment, the potential student only qualified for the Post 9/11 Bill. If the student had been eligible for other program benefits, they would also have been presented in the summary of the military education benefits 602.

The computer system 110 then displays additional state or federal aid benefit programs the potential student is eligible to receive. In the illustrated embodiment, the potential student qualified for the Pell Grant 604, and Massachusetts MASS Grant 606.

The summation of these awards is then displayed as the Total Estimated Grant Aid 608. This total includes grant eligibility from military, federal, and state sources of funding. Generally, grants and scholarships are the most desirable type of student aid because the programs do not require repayment.

The computer system also calculates additional funding source 610. This additional funding total is based on an average cost to attending post-secondary schools. This calculation helps to provide additional information associated with cost of attending a post-secondary school by enabling the student to see how much additional funding is available to attend an academic institution. A summation of the Total Estimated Grant Aid 608 and Additional funding sources 610 provides a Total Estimated Grant and Loan Aid 612. The Total Estimated Grant and Loan Aid 612 represents the total amount of grants, scholarships, and student loan eligibility available to help the potential student finance their education.

Lastly, the computer system 110 also determines eligibility for additional military education benefit programs. In the illustrated example, the potential student qualifies for the Post 9/11 housing allowance 616 and Post 9/11 Books and Supplies Stipend 618. The Post 9/11 housing allowance 616 represents the amount the potential student receives for the entire academic year. The funds can be used to reduce the amount of loans, student employment, or out-of-pocket costs. Similarly, the Post 9/11 Books and Supplies Stipend 618 is an annual stipend of $1,000 multiplied by the potential student's eligibility percentage for the Post 9/11 GI Bill.

FIG. 8. Illustrates an alternate example of the estimated military education benefit screen 600.

In this example, the potential student is eligible to receive funding from the Active Duty Military Tuition Assistance Programs and Chapter 1607 Montgomery GI Bill (REAP). As before, these benefit programs are displayed in the Military Education Benefits section 602.

The Military Tuition Assistance Program offers financial assistance to service members who elect to pursue Off-Duty or Voluntary Education. Military Tuition Assistance Program funds 100% of tuition costs for Post-Secondary institutions and high school completion programs up to a fiscal year TA cap of $4,500. To be eligible the service member must be active duty or drilling/reservist. The awarding is based on the service member's military branch (see Table VI).

TABLE VI
Tuition Assistance - Benefit Rates

| Military Branch | Current Rate |
|---|---|
| Army | $4,500 |
| Army Reserve | $4,500 |
| Army National Guard | $4,500 |
| Marine Corps | $4,500 |
| Marine Corps Reserve | $0 |
| Navy | $4,000 |
| Navy Reserve | $0 |
| Air Force | $4,500 |
| Air Force Reserve | $4,500 |
| Air Guard | $0 |
| Coast Guard | $4,500 |
| Coast Guard Reserve | $4,500 |

FIG. 8 further illustrates how each potential student receives personalized estimated eligibility aid calculations. For example, in FIG. 7, the potential student is eligible to receive federal and state aid. However, in FIG. 8, the potential student is only eligible to receive The Pell grant (Federal Aid) 604.

As before, a Total Estimated Grant Aid 608, additional funding sources 610, and Total Grant and Loan Aid 612 are also provided, but the final totals and awards are different. Additionally, the potential student does not qualify for the Post 9/11 housing allowance and/or the Post 9/11 Books and Supplies Stipend.

An additional program (not shown in the figures) is the Yellow Ribbon Grant, which is available to recipients of the Post 9/11 GI Bill with 100% benefits. For public schools, a potential student could be eligible for all in-state tuition and fees so Yellow Ribbon Program funds would not be necessary. However, Yellow Ribbon Program funds can be applied to the difference between in-state and out-of-state tuition and fees charges. For private and foreign schools, a cap of $17,500 for the Post 9/11 GI Bill begins on Aug. 8, 2011 and is applied during the academic year until it is exhausted. Yellow Ribbon funding is then available to cover the remaining tuition and fees charges. To be eligible the potential student must be eligible to receive 100% of Post 9/11 GI Bill (Chapter 33) benefits. Yellow Ribbon funding and availability varies by campus.

Lastly, there are numerous additional combinations of grants, scholarships, military benefits and loans. The illustrated examples are not intended to be an exhaustive list of all possible combinations. Rather, they represent only a few examples intended to illustrate how the present system is able to make determinations of eligibility for benefit programs and generate personalized eligibility aid calculations for each potential student.

While this invention has been particularly shown and described with references to preferred embodiments thereof, it will be understood by those skilled in the art that various changes in form and details may be made therein without departing from the scope of the invention encompassed by the appended claims.

What is claimed is:

1. A computerized method for determining military education benefits for attending an academic institution, the method comprising:
the computer system generating a user interface for receiving personal information of a candidate, the personal information including military background information;
the computer system determining eligibility for multiple military aid programs based on the military background information of the candidate;
upon selection of a military aid program by the candidate, calculating a total amount of military aid for the candidate for one or more of the programs for which the candidate is eligible; and
the computer system displaying the total amount of military aid.

2. The method according to claim 1, wherein the computer system enables entry of a length of service of the candidate and determines an amount of military aid based on the entered length of service.

3. The method according to claim 1, wherein the computer system calculates the total amount of military aid by combining military aid benefits, grants, scholarships, federal and state benefit programs, and loans.

4. The method according to claim 1, wherein the computer system enables entry of background information for the candidate including current military status of active duty, reservist/drilling, veteran, spouse/widow, or dependant/child.

5. The method according to claim 1, wherein the personal information of the candidate is stored in a database.

6. The method according to claim 1, further comprising calculating a total amount of military aid with a calculation engine, the total amount of military aid being personalized for the candidate.

7. The method according to claim 1, wherein the computer system enables selection from a list of all possible military aid programs based on the military background information for the candidate.

8. A computerized method for determining military education benefits for attending an academic institution, the method comprising:
the computer system generating a user interface for receiving personal information of a candidate, the personal information including military background information for a parent;
the computer system enabling the indication of eligibility under a transfer of benefits program;
of the computer system enabling entry of cumulative service performed by the parent;
the computer system calculating a total amount of military aid for the candidate; and
the computer system displaying the total amount of military aid for the candidate.

9. A computerized method for determining military education benefits for attending an academic institution, the method comprising:
the computer system generating a user interface for receiving personal information of a candidate, the personal information including military background information for a parent or deceased or injured spouse;
the computer system enabling indication of whether the parent or spouse was injured or killed in relation to their service;
the computer system calculating a total amount of military aid for the candidate; and
the computer system displaying the total amount of military aid for the candidate.

10. A computerized method for determining transferable military education benefits from a service member to a candidate, the method comprising:
the computer system generating a user interface for receiving personal information of a candidate, the personal information including whether the candidate is a spouse or dependant of the service member;
if the candidate is the spouse or dependant of the service member, calculating a total amount of transferrable military aid that can be received from the service member; and
the computer system displaying the total amount of transferrable military aid.

11. The method according to claim 10, wherein the computer system enables the entry of a length of service of the service member and determines an amount of military aid is based on the cumulative length of service of the service member.

12. The method according to claim 10, wherein the computer system calculates the total amount of military aid by combining military aid benefits, grants, scholarships, federal and state benefit programs, and loans.

13. The method according to claim 10, wherein the computer system enables the candidate to enter background information of the service member.

14. The method according to claim 10, wherein the personal information of the service member and candidate is stored in a database.

15. The method according to claim 10, further comprising calculating a total amount of military aid with a calculation engine, the total amount of military aid being personalized for the candidate.

16. A computerized method for determining military education benefits for attending an academic institution, the method comprising:
the computer system generating a user interface for receiving personal information of a candidate, the personal information including military background information;
in response to entered personal and military background information, determining possible military aid programs the candidate is eligible to receive;
the computer system automatically selecting military aid programs and calculating a total amount of military aid for the candidate; and
the computer system displaying the total amount of military aid for the candidate.
